(19) United States
(12) Patent Application Publication
(10) Pub. No.: US 2018/0059471 A1
(43) Pub. Date: Mar. 1, 2018

(54) DISPLAY PANEL AND DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Wenqing ZHAO, Beijing (CN); Xiaochuan CHEN, Beijing (CN); Qian WANG, Beijing (CN); Jian GAO, Beijing (CN); Pengcheng LU, Beijing (CN); Rui XU, Beijing (CN); Lei WANG, Beijing (CN); Xiaochen NIU, Beijing (CN)

(21) Appl. No.: 15/526,317

(22) PCT Filed: Sep. 14, 2016
(86) PCT No.: PCT/CN2016/099003

§ 371 Date: May 11, 2017

(30) Foreign Application Priority Data
Jan. 8, 2016 (CN) 201610012535.X

(51) Int. Cl. G02F 1/1335; G09G 3/36; G02B 5/18; G02B 5/30

(52) U.S. Cl. CPC G02F 1/133504; G02F 1/133528; G02B 5/3058; G02B 5/1866; G02B 5/1814; G09G 3/3607

(57) ABSTRACT

The present disclosure relates to a display panel and a display device. The display panel comprises a plurality of pixel units, each pixel unit including at least three sub-pixel units. A first micro-structure, a second micro-structure and a third micro-structure are respectively arranged between a side opposite to a light exit side of the display panel and a first sub-pixel unit, a second sub-pixel unit as well as a third sub-pixel unit. Incident light passing through the first micro-structure is emitted as light of a first color, incident light passing through the second micro-structure is emitted as light of a second color, and incident light passing through the third micro-structure is emitted as light of a third color.

### TECHNICAL FIELD

The present disclosure relates to the technical field of display, in particular to a display panel and a display device.

### BACKGROUND

With a constant development of the display technology, flat panel displays such as organic electroluminescence display panels, Liquid Crystal Display (LCD) panels, Light Emitting Diodes (LEDs) and Plasma Display Panels (PDPs) are developing rapidly.

As an example, an existing LCD mainly consists of an array substrate, an opposite substrate, as well as a liquid crystal layer disposed between the two substrates. Specifically, the array substrate has a gate line, a data line, a thin film transistor (TFT) and a pixel electrode arranged thereon; while the opposite substrate has a black matrix, a color filter layer and a common electrode arranged thereon. When scanning signals of a high potential are input on the gate line, the TFT connected to the gate line is in an ON state, and gray scale signals loaded on the data line are applied to the pixel electrode through the TFT. In this way, an electric field is formed between the pixel electrode and the common electrode. Liquid crystal molecules are controlled to be turned over by such an electric field, so as to modulate the backlight passing through them, such that the backlight irradiates on the color filter layer with different intensities. The color filter layer divides the white light into three primary colors of red, green and blue based on a color blocking and filtering principle, thereby realizing color display. Since the color blocking material of the color filter layer has low light transmittance, the LCD has large light loss and low light transmittance.

Therefore, how to reduce light loss of the flat panel display so as to increase light transmittance thereof becomes a technical problem to be solved by those skilled in the art.

### SUMMARY

In view of the above, embodiments of the present disclosure provide a display panel and a display device, for reducing light loss of the flat panel display so as to increase light transmittance thereof.

Therefore, an embodiment of the present disclosure provides a display panel, which comprises a plurality of pixel units. Each pixel unit includes at least three sub-pixel units. A first micro-structure, a second micro-structure and a third micro-structure are respectively arranged between a side opposite to a light exit side of the display panel and a first sub-pixel unit, a second sub-pixel unit as well as a third sub-pixel unit in each pixel unit. Incident light passing through the first micro-structure is emitted as light of a first color, incident light passing through the second micro-structure is emitted as light of a second color, and incident light passing through the third micro-structure is emitted as light of a third color.

According to one possible implementation, the above-mentioned display panel provided in an embodiment of the present disclosure further comprises: a first substrate and a second substrate arranged facing each other. A side of the first substrate facing away from the second substrate is a light exit side of the display panel. Besides, the first micro-structure, the second micro-structure and the third micro-structure are located on a side of the second substrate facing the first substrate.

According to one possible implementation, in the above-mentioned display panel provided in an embodiment of the present disclosure, each of the first micro-structure, the second micro-structure and the third micro-structure includes a plurality of micro-structure prisms located on the second substrate and protruding toward the first substrate. Each micro-structure prism has an inclined surface. Besides, the plurality of micro-structure prisms is configured to enable light incident into the second substrate to emit as light of a particular wavelength.

According to one possible implementation, the above-mentioned display panel provided in an embodiment of the present disclosure further comprises a protective film located on a side of the second substrate facing the first substrate and being contact with the second substrate.

According to one possible implementation, the above-mentioned display panel provided in an embodiment of the present disclosure further comprises a first substrate and a second substrate arranged facing each other, as well as an optical film located on a side of the second substrate facing the first substrate. A side of the first substrate facing away from the second substrate is the light exit side of the display panel. Furthermore, the first micro-structure, the second micro-structure and the third micro-structure are located on a side of the optical film facing the first substrate.

According to one possible implementation, in the above-mentioned display panel provided in an embodiment of the present disclosure, each of the first micro-structure, the second micro-structure and the third micro-structure includes a plurality of micro-structure prisms located on the optical film and protruding toward the first substrate. Each micro-structure prism has an inclined surface. Besides, the plurality of micro-structure prisms is configured to enable light incident into the optical film to emit as light of a particular wavelength.

According to one possible implementation, in the above-mentioned display panel provided in an embodiment of the present disclosure, materials suitable for the optical film comprise organic resin.

According to one possible implementation, the above-mentioned display panel provided in an embodiment of the present disclosure further comprises a protective film, which is located on a side of the optical film facing the first substrate and contact with the optical film.

According to one possible implementation, in the above-mentioned display panel provided in an embodiment of the present disclosure, each of the micro-structure prisms satisfies the formula of 2d sin γ=λ, wherein λ is a wavelength of light emitting from the micro-structure prism, d is a width of the micro-structure prism, and γ is an inclination angle of the inclined surface of the micro-structure prism.

According to one possible implementation, the above-mentioned display panel provided in an embodiment of the present disclosure further comprises a liquid crystal layer between the first substrate and the second substrate. The first substrate is an opposite substrate, and the second substrate is an array substrate. Alternatively, the first substrate is an array substrate, and the second substrate is an opposite substrate.

According to one possible implementation, the above-mentioned display panel provided in an embodiment of the present disclosure further comprises an organic electroluminescence structure located on a side of the second substrate facing the first substrate. In this case, the optical film is located on a side of the organic electroluminescence structure facing the first substrate.

An embodiment of the present disclosure further provides a display device, which comprises the above-mentioned display panel provided in an embodiment of the present disclosure.

Embodiments of the present disclosure provide the above-mentioned display panel and display device. The display panel comprises a plurality of pixel units, each pixel unit including at least three sub-pixel units. A first micro-structure, a second micro-structure and a third micro-structure are respectively arranged between a side opposite to a light exit side of the display panel and a first sub-pixel unit, a second sub-pixel unit as well as a third sub-pixel unit. Incident light passing through the first micro-structure is emitted as light of a first color, incident light passing through the second micro-structure is emitted as light of a second color, and incident light passing through the third micro-structure is emitted as light of a third color. In this way, white light can be divided into light of different colors by the micro-structures, thereby realizing color display. In other words, by replacing color filter layers of the color blocking material with micro-structures, light loss of the display panel is reduced, light transmittance of the display panel is increased, and thus power consumption of the display panel is reduced accordingly.

### BRIEF DESCRIPTION OF THE DRAWINGS

FIGS. 1-10 shows respectively structural diagrams of an display panel provided in an embodiment of the present disclosure; and

FIG. 11 shows a spectral energy distribution of a superposition of interference and diffraction for the micro-structure prisms in an display panel provided in an embodiment of the present disclosure.

### DETAILED DESCRIPTION OF THE EMBODIMENTS

To further clarify the object, technical solution and advantages of the present disclosure, a more particular description of the present disclosure will be rendered with reference to the drawings. Obviously, the described embodiments are merely some instead of all of the embodiments of the present disclosure. All other embodiments that can be obtained by those skilled in the art on the basis of the embodiments in the present disclosure without using inventive skills shall fall into the protection scope of the present disclosure.

Shapes and thicknesses of different film layers shown in the figures do not reflect the true proportion, but only intend to schematically depict the present disclosure.

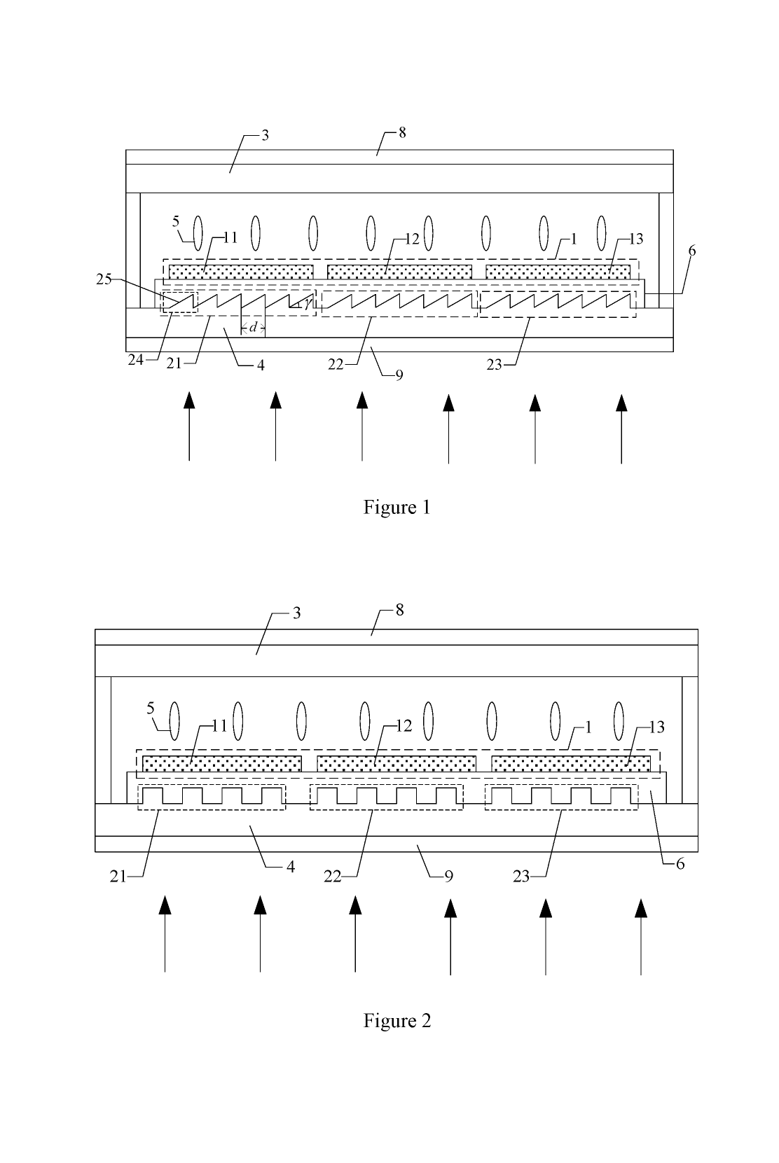

An embodiment of the present disclosure provides a display panel. As shown in FIGS. 1-10, the display panel comprises: a plurality of pixel units 1 (FIGS. 1-10 only show one pixel unit 1), each pixel unit including at least three sub-pixel units. FIGS. 1-10 give illustrations by taking an example where each pixel unit 1 includes a first sub-pixel unit 11, a second sub-pixel unit 12 and a third sub-pixel unit 13.

A first micro-structure 21, a second micro-structure 22 and a third micro-structure 23 are respectively arranged between a side opposite to a light exit side of the display panel and a first sub-pixel unit 11, a second sub-pixel unit 12 as well as a third sub-pixel unit 13 in each of the pixel units 1. Incident light passing through the first micro-structure 21 is emitted as light of a first color, incident light passing through the second micro-structure 22 is emitted as light of a second color, and incident light passing through the third micro-structure 23 is emitted as light of a third color.

In the display panel provided in an embodiment of the present disclosure, a first micro-structure, a second micro-structure and a third micro-structure are arranged corresponding to the first sub-pixel unit, the second sub-pixel unit and the third sub-pixel unit, respectively. Besides, incident light is emitted as light of a first color after passing through the first micro-structure, incident light is emitted as light of a second color after passing through the second micro-structure, and incident light is emitted as light of a third color after passing through the third micro-structure. In this way, white light can be divided into light of different colors by the micro-structures, thereby realizing color display. In other words, by replacing color filter layers of the color blocking material with micro-structures, light loss of the display panel can be reduced, light transmittance of the display panel can be increased, and thus power consumption of the display panel can be reduced accordingly.

According to a specific embodiment, in the display panel provided in an embodiment of the present disclosure, when each pixel unit includes three sub-pixel units, color display is usually achieved by the three primary colors of red (R), green (G) and blue (B). Specifically, the first color can be red (R), the second color can be green (G), and the third color can be (B). That is, incident light passing through the first micro-structure 21 is emitted as red (R) light, incident light passing through the second micro-structure 22 is emitted as green (G) light, and incident light passing through the third micro-structure 23 is emitted as blue (B) light. Of course, the first color, second color and third color can also be other combinations of red (R), green (G) and blue (B), which will not be limited herein.

When each pixel unit includes four sub-pixel units, the color display can be realized by red (R), green (G), blue (B) and yellow (Y). Alternatively, the color display can be realized by other colors, which will not be limited herein.

It shall be noted that the display panel provided in an embodiment of the present disclosure can be applied to flat panel displays such as organic electroluminescence display panels, Liquid Crystal Display (LCD) panels, Light Emitting Diodes (LEDs) and Plasma Display Panels (PDPs), which will not be limited herein.

According to a specific embodiment, as shown in FIGS. 1-4, the display panel provided in an embodiment of the present disclosure can further comprise a first substrate 3 and a second substrate 4 arranged facing each other. Further, a side of the first substrate 3 facing away from the second substrate 4 is the light exit side of the display panel as indicated above. Further, the first micro-structure 21, the second micro-structure 22 and the third micro-structure 23 can be located on a side of the second substrate 4 facing the first substrate 3. To be specific, the second substrate 4 can be glass. Since glass has high light transmittance, compared to existing display panels in which color display is realized by color filter layers of a color blocking material, the display panel provided in an embodiment of the present disclosure realizes color display by means of the first micro-structure 21, the second micro-structure 22 and the third micro-structure 23 on a surface of the second substrate 4. In this way, on the one hand, light loss of the display panel can be reduced, light transmittance of the display panel can be increased, and thus power consumption of the display panel can be reduced accordingly. On the other hand, since the color filter layer is omitted, and the first micro-structure 21, the second micro-structure 22 and the third micro-structure 23 are directly fabricated on a surface of the second substrate 4, thickness of the display panel can be reduced, so as to be suitable for the development trend of being light and thin.

Two specific examples will be given below to describe in detail the implementation when the display panel provided in an embodiment of the present disclosure (in which the first micro-structure, the second micro-structure and the third micro-structure are located on a side of the second substrate facing the first substrate) is applied to an LCD.

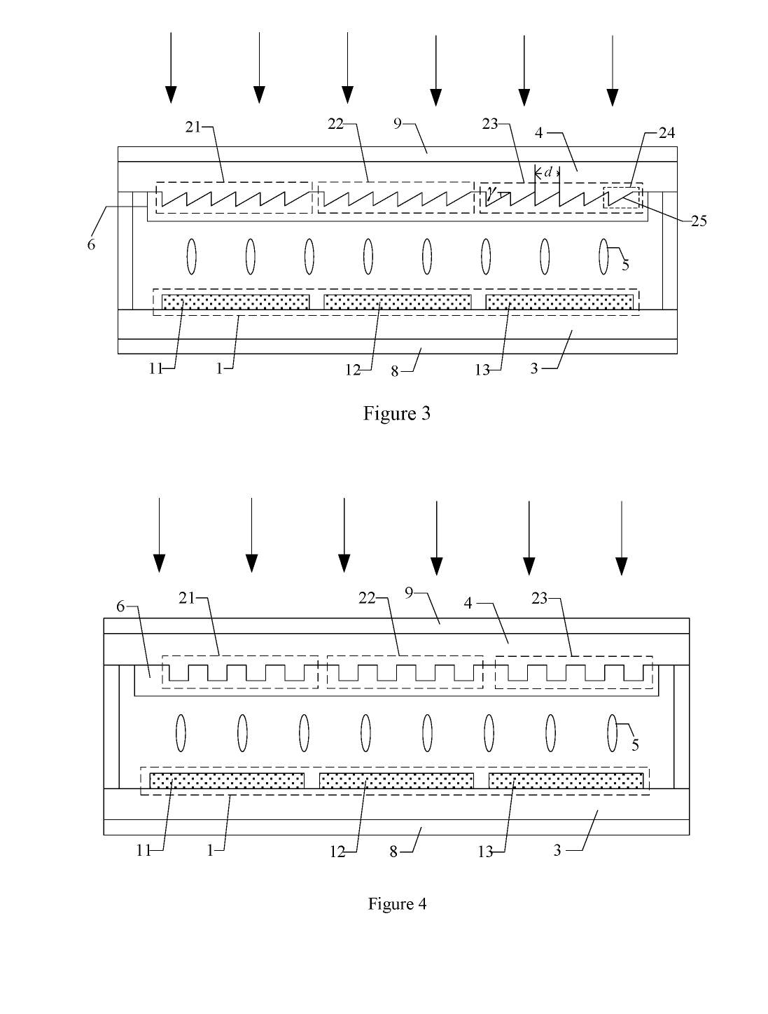

Specifically, when the display panel provided in an embodiment of the present disclosure is applied to an LCD, as shown in FIGS. 1-4, the display panel provided in an embodiment of the present disclosure can further comprise a liquid crystal layer 5 between the first substrate 3 and the second substrate 4. To be specific, as shown in FIGS. 1 and 2, the first substrate 3 can be an opposite substrate, and the second substrate 4 is an array substrate. That is, a side of the opposite substrate (i.e. first substrate 3) facing away from the array substrate (i.e. second substrate 4) is a light exit side of the LCD. Then, backlight of the LCD is incident from a side of the array substrate (i.e. second substrate 4), as shown by arrows in FIGS. 1 and 2. Besides, the first micro-structure 21, the second micro-structure 22 and the third micro-structure 23 are located on a side of the array substrate (i.e. second substrate 4) facing the opposite substrate (i.e. first substrate 3). Alternatively, as shown in FIGS. 3 and 4, the first substrate 3 can be an array substrate, and the second substrate 4 is an opposite substrate. That is, a side of the array substrate ((i.e. first substrate 3) facing away from the opposite substrate ((i.e. second substrate 4) is the light exit side of the LCD. Then, backlight of the LCD is incident from a side of the opposite substrate ((i.e. second substrate 4), as shown by arrows in FIGS. 3 and 4. Further, the first micro-structure 21, the second micro-structure 22 and the third micro-structure 23 are located on a side of the opposite substrate ((i.e. second substrate 4) facing the array substrate ((i.e. first substrate 3).

In a specific example, as shown in FIGS. 1 and 2, the display panel provided in an embodiment of the present disclosure is applied to an LCD. In this case, the first micro-structure 21, the second micro-structure 22 and the third micro-structure 23 are located on a side of the array substrate ((i.e. second substrate 4) facing the opposite substrate ((i.e. first substrate 3). Furthermore, each sub-pixel unit includes a pixel electrode and a thin film transistor, and is also located on a side of the array substrate ((i.e. second substrate 4) facing the opposite substrate ((i.e. first substrate 3).

According to a specific embodiment, as shown in FIG. 1, in the display panel provided in an embodiment of the present disclosure, each of the first micro-structure 21, the second micro-structure 22 and the third micro-structure 23 may include a plurality of micro-structure prisms 24, which are located on the second substrate 4 ((i.e. array substrate) and protrudes toward the first substrate 3 ((i.e. opposite substrate). Each micro-structure prism 24 has an inclined surface 25. Besides, the plurality of micro-structure prisms 24 work together to enable light incident into the second substrate 4 ((i.e. array substrate) to emit as light of a particular wavelength.

The principle of dividing an incident white light into RGB lights by the micro-structure prisms will be described in detail below. Each micro-structure prism has diffraction characteristics, and the plurality of micro-structure prisms have interference enhancement characteristics. Besides, the formula of 2d sin γ=mλ is satisfied, wherein λ is a wavelength of light emitted from the micro-structure prism, d is a width of the micro-structure prism, γ is an inclination angle of the inclined surface of the micro-structure prism, and in is a positive integer. FIG. 11 shows a spectral energy distribution of a superposition of interference and diffraction for the micro-structure prisms. It can be seen from FIG. 11 that when m=1, light emitted from the micro-structure prisms has its strongest intensity, i.e. a first order light intensity of a particular wavelength is the strongest. In this case, the above formula can be simplified into the following form: 2d sin γ=λ. When the inclination angle γ of the inclined surface of the micro-structure prism and the width d of the micro-structure prism are fixed, the wavelength of light emitted from the micro-structure prism is fixed. Therefore, by adjusting the inclination angle γ of the inclined surface of the micro-structure prism and the width d of the micro-structure prism, light of a desired wavelength can be emitted from the micro-structure prism. That is, light of desired colors, e.g. RGB lights, can be emitted from the micro-structure prism. Specifically, red light corresponds to a wavelength range of 630 nm-780 nm and its representative wavelength is 700 nm, green light corresponds to a wavelength range of 500 nm-570 nm and its representative wavelength is 550 nm, while blue light corresponds to a wavelength range of 420 nm-470 nm and its representative wavelength is 470 nm. Taking the representative wavelength as an example, the micro-structure prism can be designed as follows: given the inclination angle γ of the inclined surface of the micro-structure prism to be 15°, when the width d of the micro-structure prism is 1.35 μm, the micro-structure prism can emit light R having a wavelength of 700 nm; when the width d of the micro-structure prism is 1.06 μm, the micro-structure prism can emit light G having a wavelength of 550 nm; and when the width d of the micro-structure prism is 0.91 μm, the micro-structure prism can emit light B having a wavelength of 470 nm.

It shall be appreciated that the RGB light needed for the display panel is light having a certain range of wavelengths, while the plurality of micro-structure prisms in the display panel provided in an embodiment of the present disclosure can only emit light of a certain specific wavelength. In view of this, it is required that different micro-structure prisms corresponding to each sub-pixel unit have different widths d and/or different inclination angles γ of the inclined surfaces. Thus, it can be ensured that the micro-structure prisms corresponding to each of the sub-pixel units emit RGB lights having a certain range of wavelengths.

According to a specific embodiment, as shown in FIG. 2, in the display panel provided in an embodiment of the present disclosure, the first micro-structure 21, the second micro-structure 22 and the third micro-structure 23 can also be concave and convex micro-structures, which are located on the second substrate 4 (i.e. array substrate) and face the first substrate 3 (i.e. opposite substrate). The concave and convex micro-structures are nanoscale patterns. Through the nanoscale patterns, incident light is subject to diffraction and interference, so as to generate light dispersion and to divide white light into RGB lights. The principle for such concave and convex micro-structures to divide a white light into RGB lights is similar to the principle of the micro-structure prism, so it will not elaborated herein anymore.

Alternatively, as shown in FIGS. 1 and 2, the display panel provided in an embodiment of the present disclosure can further comprise a protective film 6, which is located on a side of the second substrate 4 (i.e. array substrate) facing the first substrate 3 (i.e. opposite substrate) and contact with the second substrate 4 (i.e. array substrate). On the one hand, the protective film 6 can protect the first micro-structure 21, the second micro-structure 22 and the third micro-structure 23 from damage. On the other hand, the protective film 6 can also provide a divergence distance, so that the first micro-structure 21, the second micro-structure 22 and the third micro-structure 23 can divide the white light into stable RGB lights. In this way, the RGB lights obtained through the micro-structures are more stable. Accordingly, display effect of the display panel is further optimized.

It shall be noted that in the display panel provided in an embodiment of the present disclosure, the first micro-structure, the second micro-structure and the third micro-structure, as well as the pixel units are all disposed on a side of the array substrate facing the opposite substrate. Thus, precise alignment can be achieved between the first micro-structure and the first sub-pixel unit, between the second micro-structure and the second sub-pixel unit, and between the third micro-structure and the third sub-pixel unit. In this way, imprecise alignment in cell assembling can be avoided.

In another example, as shown in FIGS. 3 and 4, the display panel provided in an embodiment of the present disclosure can be applied to an LCD. Specifically, the first micro-structure 21, the second micro-structure 22 and the third micro-structure 23 are located on a side of the opposite substrate (i.e. second substrate 4) facing the array substrate (i.e. first substrate 3). Besides, each sub-pixel unit includes a pixel electrode and a thin film transistor, and is also located on a side of the array substrate (i.e. first substrate 3) facing the opposite substrate (i.e. second substrate 4).

According to a specific embodiment, as shown in FIG. 3, in the display panel provided in an embodiment of the present disclosure, each of the first micro-structure 21, the second micro-structure 22 and the third micro-structure 23 may include a plurality of micro-structure prisms 24, which are located on the second substrate 4 (i.e. opposite substrate) and protrude toward the first substrate 3 (i.e. array substrate). Each micro-structure prism 24 has an inclined surface 25. Additionally, the plurality of micro-structure prisms 24 works together, so as to enable light incident into the second substrate 4 (i.e. opposite substrate) to be emitted as light of a particular wavelength.

Alternatively, as shown in FIG. 4, in the display panel provided in an embodiment of the present disclosure, the first micro-structure 21, the second micro-structure 22 and the third micro-structure 23 can also be concave and convex micro-structures, which are located on the second substrate 4 (i.e. opposite substrate) and face the first substrate 3 (i.e. array substrate). The concave and convex micro-structures are nanoscale patterns. Through the nanoscale patterns, incident light is subject to diffraction and interference, so as to generate light dispersion and to divide white light into RGB lights. The principle for such concave and convex micro-structures to divide the white light into RGB lights is similar to the principle of the micro-structure prism, so it will not elaborated herein anymore.

Optionally, as shown in FIGS. 3 and 4, the display panel provided in an embodiment of the present disclosure can further comprise a protective film 6, which is located on a side of the second substrate 4 (i.e. opposite substrate) facing the first substrate 3 (i.e. array substrate) and contact with the second substrate 4 (i.e. opposite substrate). On the one hand, the protective film 6 can protect the first micro-structure 21, the second micro-structure 22 and the third micro-structure 23 from damage. On the other hand, the protective film 6 can also provide a divergence distance, so that the first micro-structure 21, the second micro-structure 22 and the third micro-structure 23 can divide the white light into stable RGB lights. In this way, the RGB lights obtained through the micro-structures are more stable. Accordingly, display effect of the display panel is optimized.

It shall be noted that the specific implementation process of the above-described embodiments is similar to the implementation process of the previously described first embodiment, so the repetitions will not be elaborated.

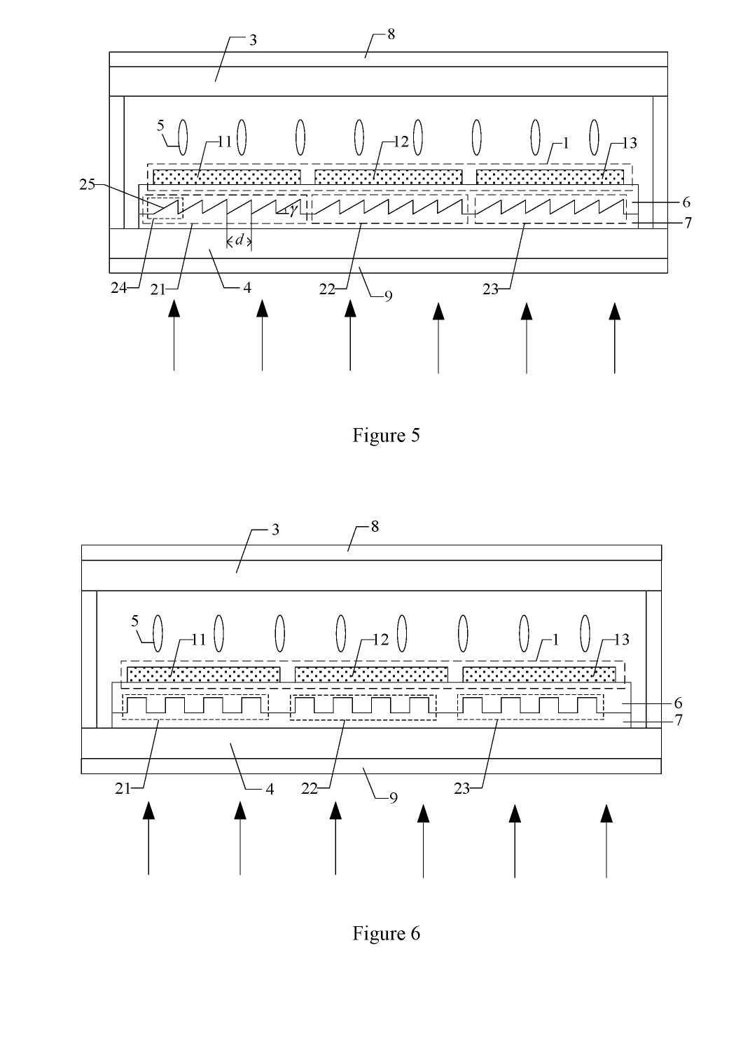

In view of the difficulty in fabricating the micro-structures directly on the surface of the second substrate, according to a specific embodiment, as shown in FIGS. 5-10, the display panel provided in an embodiment of the present disclosure can further comprise a first substrate 3 and a second substrate 4 arranged facing each other. Besides, an optical film 7 is also included, which is located on a side of the second substrate 4 facing the first substrate 3. Further, a side of the first substrate 3 facing away from the second substrate 4 is a light exit side of the display panel. Further, the micro-structures 2 are located on a side of the optical film 7 facing the first substrate 3. Namely, the optical film is disposed on the second substrate. Compared to the procedure in which the micro-structures are fabricated on a surface of the second substrate, the fabrication process of the micro-structures can be simplified when the micro-structures are fabricated on a surface of the optical film. In addition, compared to existing display panels in which color display is realized by color filter layers of a color blocking material, the display panel provided in an embodiment of the present disclosure realizes color display by means of the micro-structures on a surface of the optical film. In this way, light loss of the display panel can be reduced, light transmittance of the display panel can be increased, and thus power consumption of the display panel can be reduced accordingly.

Two specific examples will be given below to describe in detail implementations when the display panel provided in an embodiment of the present disclosure (in which the first micro-structure, the second micro-structure and the third micro-structure are located on a side of the optical film facing the first substrate) is applied to an LCD.

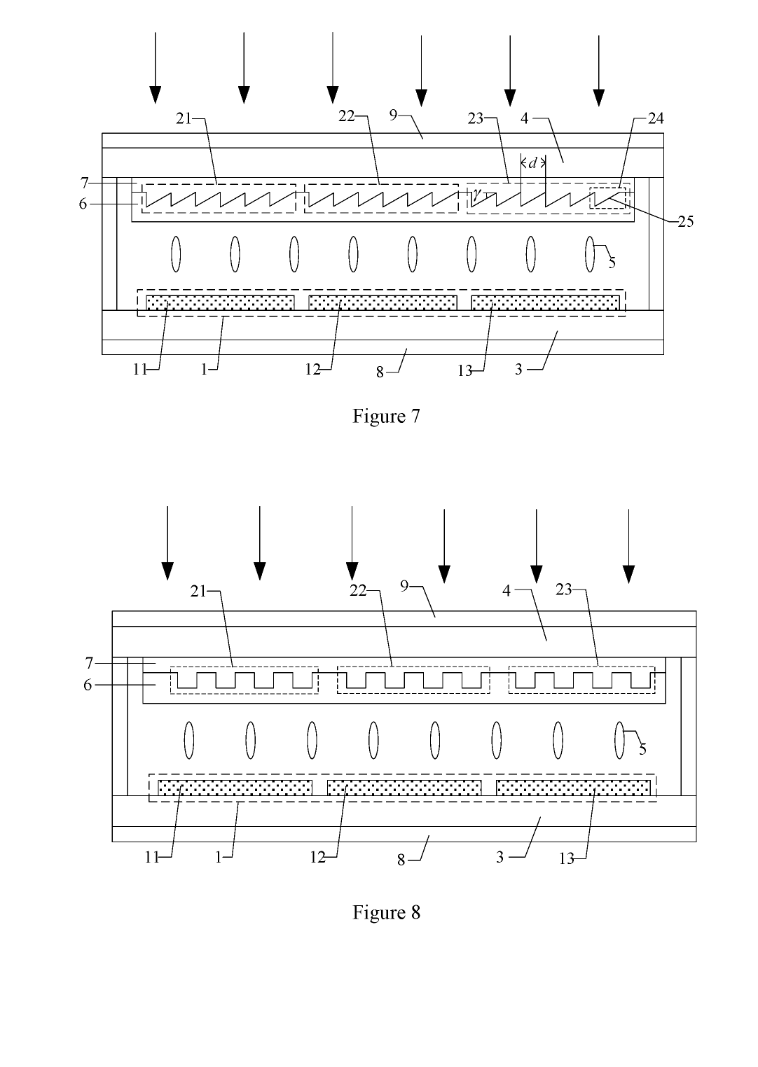

Specifically, when the display panel provided in an embodiment of the present disclosure is applied to an LCD, as shown in FIGS. 5-8, the display panel provided in an embodiment of the present disclosure can further comprise a liquid crystal layer 5 between the first substrate 3 and the second substrate 4. To be specific, as shown in FIGS. 5 and 6, the first substrate 3 can be an opposite substrate and the second substrate 4 is an array substrate. That is, a side of the opposite substrate (i.e. first substrate 3) facing away from the array substrate (i.e. second substrate 4) is a light exit side of the LCD. Then, backlight of the LCD enters from a side of the array substrate (i.e. second substrate 4), as shown by arrows in FIGS. 5 and 6. Additionally, the first micro-structure 21, the second micro-structure 22 and the third micro-structure 23 are located on a side of the array substrate to (i.e. second substrate 4) facing the opposite substrate (i.e. first substrate 3). Alternatively, as shown in FIGS. 7 and 8, the first substrate 3 can be an array substrate and the second substrate 4 is an opposite substrate. That is, a side of the array substrate (i.e. first substrate 3) facing away from the opposite substrate (i.e. second substrate 4) is the light exit side of the LCD. Then, backlight of the LCD enters from a side of the opposite substrate (i.e. second substrate 4), as shown by arrows in FIGS. 7 and 8. Besides, the first micro-structure 21, the second micro-structure 22 and the third micro-structure 23 are located on a side of the opposite substrate (i.e. second substrate 4) facing the array substrate (i.e. first substrate 3).

In another example, as shown in FIGS. 5 and 6, the display panel provided in an embodiment of the present disclosure can be applied to an LCD. At this time, the first micro-structure 21, the second micro-structure 22 and the third micro-structure 23 are located on a side of the optical film 7 on the array substrate (i.e. second substrate 4) facing the opposite substrate (i.e. first substrate 3). Besides, each sub-pixel unit includes a pixel electrode and a thin film transistor, and is located on a side of the array substrate (i.e. second substrate 4) facing the opposite substrate (i.e. first substrate 3). Specifically, as shown in FIGS. 5 and 6, the optical film 7 can be disposed between a film layer where pixel units 1 are located and the second substrate 4. Alternatively, the optical film can be disposed on a side of the film layer, where pixel units are located, facing away from the second substrate (i.e. array substrate), which is not limited herein.

According to a specific embodiment, as shown in FIG. 5, in the display panel provided in an embodiment of the present disclosure, each of the first micro-structure 21, the second micro-structure 22 and the third micro-structure 23 may include a plurality of micro-structure prisms 24, which is located on the optical film 7 and protrudes toward the first substrate 3 (i.e. opposite substrate). Each micro-structure prism 24 has an inclined surface 25. In this case, the plurality of micro-structure prisms 24 works together to enable light incident into the optical film 7 to be emitted as light of a particular wavelength. The principle for the micro-structure prisms to divide the white light into RGB lights is similar to the principle of the above-described first embodiment, so it will not elaborated herein anymore.

According to a specific embodiment, as shown in FIG. 6, in the display panel provided in an embodiment of the present disclosure, the first micro-structure 21, the second micro-structure 22 and the third micro-structure 23 can also be concave and convex micro-structures, which are located on the optical film 7 and face the first substrate 3 (i.e. opposite substrate). The concave and convex micro-structures are nanoscale patterns. By means of the nanoscale patterns, incident light is subject to diffraction and interference, so as to generate light dispersion and to divide white light into RGB lights. The principle for such concave and convex micro-structures to divide the white light into RGB lights is similar to the principle of the micro-structure prism, so it will not elaborated herein anymore.

Alternatively, as shown in FIGS. 5 and 6, the display panel provided in an embodiment of the present disclosure can further comprise a protective film 6, which is located on a side of the second substrate 4 (i.e. array substrate) facing the first substrate 3 (i.e. opposite substrate) and contact with the optical film 7. On the one hand, the protective film 6 can protect the first micro-structure 21, the second micro-structure 22 and the third micro-structure 23 from damage. On the other hand, the protective film 6 can also provide a divergence distance, so that the first micro-structure 21, the second micro-structure 22 and the third micro-structure 23 can divide the white light into stable RGB lights. In this way, the RGB lights obtained by the micro-structures are more stable. Accordingly, display effect of the display panel is optimized.

According to a specific embodiment, in the display panel provided in an embodiment of the present disclosure, materials suitable for the optical film can be organic resin. Of course, materials suitable for the optical film are not limited to this, and it can be other materials having high light transmittance, which is not limited herein.

It shall be noted that in the display panel provided in an embodiment of the present disclosure, the first micro-structure, the second micro-structure and the third micro-structure, as well as the pixel units are all disposed on a side of the array substrate facing the opposite substrate. Thus, precise alignment can be achieved between the first micro-structure and the first sub-pixel unit, between the second micro-structure and the second sub-pixel unit, and between the third micro-structure and the third sub-pixel unit. In this way, imprecise alignment in cell assembling can be avoided.

In still another example, as shown in FIGS. 7 and 8, the display panel provided in an embodiment of the present disclosure can be applied to an LCD. Specifically, the first micro-structure 21, the second micro-structure 22 and the third micro-structure 23 are located on a side of the optical film 7 on the opposite substrate (i.e. second substrate 4) facing the array substrate (i.e. first substrate 3). In this case, each sub-pixel unit includes a pixel electrode and a thin film transistor, and is located on a side of the array substrate (i.e. first substrate 3) facing the opposite substrate (i.e. second substrate 4).

According to a specific embodiment, as shown in FIG. 7, in the display panel provided in an embodiment of the present disclosure, each of the first micro-structure 21, the second micro-structure 22 and the third micro-structure 23 may include a plurality of micro-structure prisms 24, which are located on the optical film 7 and protrude toward the first substrate 3 (i.e. array substrate). Each micro-structure prism 24 has an inclined surface 25. The plurality of micro-structure prisms 24 are generally used to enable light incident into the optical film 7 to emit as light of a particular wavelength. The principle for the micro-structure prisms to divide the white light into RGB lights is similar to the case described above by reference to the first embodiment, so it will not elaborated herein anymore.

According to a specific embodiment, as shown in FIG. 8, in the display panel provided in an embodiment of the present disclosure, the first micro-structure 21, the second micro-structure 22 and the third micro-structure 23 can also be concave and convex micro-structures, which are positioned on the optical film 7 and face the first substrate 3 (i.e. array substrate). The concave and convex micro-structures are nanoscale patterns. By means of the nanoscale patterns, incident light is subject to diffraction and interference, so as to generate light dispersion and to divide white light into RGB lights. The principle for such concave and convex micro-structures to divide the white light into RGB lights is similar to the principle of the micro-structure prism, so it will not elaborated herein anymore.

Optionally, as shown in FIGS. 7 and 8, the display panel provided in an embodiment of the present disclosure can further comprise a protective film 6, which is located on a side of the second substrate 4 (i.e. opposite substrate) facing the first substrate 3 (i.e. array substrate) and contact with the optical film 7. On the one hand, the protective film 6 can protect the first micro-structure 21, the second micro-structure 22 and the third micro-structure 23 from damage. On the other hand, the protective film 6 can also provide a divergence distance, so that the first micro-structure 21, the second micro-structure 22 and the third micro-structure 23 can divide the white light into stable RGB lights. In this way, the RGB lights obtained by the micro-structures are more stable. Accordingly, display effect of the display panel is optimized.

According to a specific embodiment, in the display panel provided in an embodiment of the present disclosure, materials suitable for the optical film can be organic resin. Of course, materials suitable for the optical film are not limited to this, and it can be other materials having high light transmittance, which is not limited herein.

It shall be noted that when the display panel provided in an embodiment of the present disclosure is applied to an LCD, the backlight unit can be a white light source. In this case, as shown in FIGS. 1-8, a first polarizer 8 is required to be disposed on a side of the first substrate 3 facing away from the second substrate 4, and a second polarizer 9 is required to be disposed on a side of the second substrate 4 facing away from the first substrate 3. Alternatively, the backlight unit can also be a polarized light source. In this case, the second polarizer can be omitted. Specifically, the backlight unit can be OLED or LED, etc., which is not limited herein.

Next, a specific example will be given to describe in detail implementations when the display panel provided in an embodiment of the present disclosure (in which the first micro-structure, the second micro-structure and the third micro-structure are located on a side of the optical film facing the first substrate) is applied to an OLED.

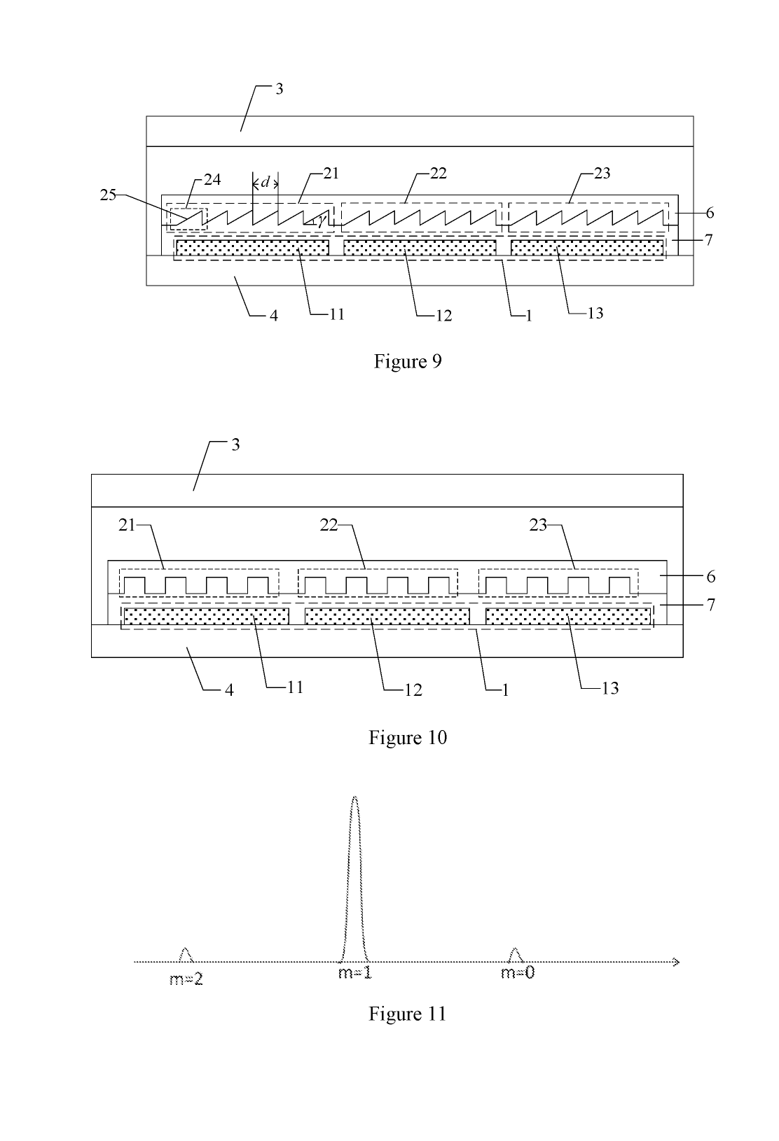

In a specific example, as shown in FIGS. 9 and 10, the display panel provided in an embodiment of the present disclosure can further comprise an organic electroluminescence structure (including an anode, a light emitting layer and a cathode) located on a side of the second substrate 4 facing the first substrate 3. Each sub-pixel unit includes the organic electroluminescence structure and a thin film transistor. Besides, the optical film 7 is disposed on a side of the film layer, where the organic electroluminescence structure is located, facing the first substrate 3.

According to a specific embodiment, as shown in FIG. 9, in the display panel provided in an embodiment of the present disclosure, each of the first micro-structure 21, the second micro-structure 22 and the third micro-structure 23 may include a plurality of micro-structure prisms 24, which is located on the optical film 7 and protrudes toward the first substrate 3. Each micro-structure prism 24 has an inclined surface 25. The plurality of micro-structure prisms 24 is used to enable light incident into the optical film 7 to emit as light of a particular wavelength. The principle for the micro-structure prisms to divide the white light into RGB lights is similar to the principle of the first embodiment, so it will not elaborated herein anymore.

According to a specific embodiment, as shown in FIG. 10, in the display panel provided in an embodiment of the present disclosure, the first micro-structure 21, the second micro-structure 22 and the third micro-structure 23 can also be concave and convex micro-structures, which are located on the optical film 7 and face the first substrate 3. The concave and convex micro-structures are nanoscale patterns. By means of the nanoscale patterns, incident light is subject to diffraction and interference, so as to generate light dispersion and to divide white light into RGB lights. The principle for such concave and convex micro-structures to divide the white light into RGB lights is similar to the principle of the micro-structure prism, so it will not elaborated herein anymore.

Optionally, as shown in FIGS. 9 and 10, the display panel provided in an embodiment of the present disclosure can further comprise a protective film 6, which is located on a side of the second substrate 4 facing the first substrate 3 and contact with the optical film. On the one hand, the protective film 6 can protect the first micro-structure 21, the second micro-structure 22 and the third micro-structure 23 from being damaged. On the other hand, the protective film 6 can also provide a divergence distance, so that the first micro-structure 21, the second micro-structure 22 and the third micro-structure 23 can divide the white light into stable RGB lights. In this way, the RGB lights obtained using the micro-structures are more stable. Accordingly, display effect of the display panel is optimized.

According to a specific embodiment, in the display panel provided in an embodiment of the present disclosure, materials suitable for the optical film can be organic resin. Of course, materials suitable for the optical film are not limited to this. It can also be other materials having high light transmittance, which is not limited herein.

Based on a same concept, an embodiment of the present disclosure further provides a display device, which comprises the above display panel provided in an embodiment of the present disclosure. The display device can be any product or component having a display function, such as a cell phone, a tablet computer, a television, a monitor, a laptop computer, a digital photo frame and a navigator. As for implementation of the display device, reference can be made to the above embodiments for the display panel, so it will not be repeated anymore.

Embodiments of the present disclosure provide a display panel and a display device. The display panel comprises a plurality of pixel units, each including at least three sub-pixel units. A first micro-structure, a second micro-structure and a third micro-structure are respectively arranged between a side opposite to a light exit side of the display panel and a first sub-pixel unit, a second sub-pixel unit as well as a third sub-pixel unit. Incident light passing through the first micro-structure is emitted as light of a first color, incident light passing through the second micro-structure is emitted as light of a second color, and incident light passing through the third micro-structure is emitted as light of a third color. In this way, white light can be divided into light of different colors by means of the micro-structures, thereby realizing color display. In other words, by replacing color filter layers of the color blocking material with micro-structures, light loss of the display panel can be reduced, light transmittance of the display panel can be increased, and power consumption of the display panel can be reduced accordingly.

Those skilled in the art can apparently make various modifications and changes to the present disclosure without departing from the spirit and scope of the present disclosure. Therefore, the present disclosure intends to include these modifications and changes as long as they fall into the scope defined by the appended claims and their equivalents.

1. A display panel, comprising a plurality of pixel units, each pixel unit including at least three sub-pixel units, wherein
a first micro-structure, a second micro-structure and a third micro-structure are respectively arranged between a side opposite to a light exit side of the display panel and a first sub-pixel unit, a second sub-pixel unit as well as a third sub-pixel unit in each pixel unit, and
incident light passing through the first micro-structure is emitted as light of a first color, incident light passing through the second micro-structure is emitted as light of a second color, and incident light passing through the third micro-structure is emitted as light of a third color.

2. The display panel according to claim 1, further comprising: a first substrate and a second substrate arranged facing each other, wherein
a side of the first substrate facing away from the second substrate is the light exit side of the display panel, and
the first micro-structure, the second micro-structure and the third micro-structure are located on a side of the second substrate facing the first substrate.

3. The display panel according to claim 2, wherein
each of the first micro-structure, the second micro-structure and the third micro-structure includes a plurality of micro-structure prisms located on the second substrate and protruding toward the first substrate, each micro-structure prism having an inclined surface, and the plurality of micro-structure prisms being configured to enable light incident into the second substrate to emit as light of a particular wavelength.

4. The display panel according to claim 2, further comprising a protective film located on a side of the second substrate facing the first substrate and being in contact with the second substrate.

5. The display panel according to claim 1, further comprising:
a first substrate and a second substrate arranged facing each other, and
an optical film located on a side of the second substrate facing the first substrate, wherein
a side of the first substrate facing away from the second substrate is the light exit side of the display panel, and
the first micro-structure, the second micro-structure and the third micro-structure are located on a side of the optical film facing the first substrate.

6. The display panel according to claim 5, wherein
each of the first micro-structure, the second micro-structure and the third micro-structure includes a plurality of micro-structure prisms located on the optical film and protruding toward the first substrate, each micro-structure prism having an inclined surface, and the plurality of micro-structure prisms being configured to enable light incident into the optical film to emit as light of a particular wavelength.

7. The display panel according to claim 5, wherein materials suitable for the optical film comprise organic resin.

8. The display panel according to claim 5, further comprising a protective film located on a side of the optical film facing the first substrate and being contact with the optical film.

9. The display panel according to claim 3, wherein
each micro-structure prism satisfies the formula of 2d sin γ=λ, wherein λ is a wavelength of light emitting from the micro-structure prism, d is a width of the micro-structure prism, and γ is an inclination angle of the inclined surface of the micro-structure prism.

10. The display panel according to claim 2, further comprising a liquid crystal layer between the first substrate and the second substrate, wherein
the first substrate is one of an opposite substrate and an array substrate, and the second substrate is the other of the opposite substrate and the array substrate.

11. The display panel according to claim 2, further comprising an organic electroluminescence structure located on a side of the second substrate facing the first substrate, wherein the optical film is located on a side of the organic electroluminescence structure facing the first substrate.

12. A display device, comprising the display panel according to claim 1.

13. The display panel according to claim 3, further comprising a protective film located on a side of the second substrate facing the first substrate and being in contact with the second substrate.

14. The display panel according to claim 6, wherein materials suitable for the optical film comprise organic resin.

15. The display panel according to claim 6, further comprising a protective film located on a side of the optical film facing the first substrate and being contact with the optical film.

16. The display panel according to claim 6, wherein
each micro-structure prism satisfies the formula of 2d sin γ=λ, wherein λ is a wavelength of light emitting from the micro-structure prism, d is a width of the micro-structure prism, and γ is an inclination angle of the inclined surface of the micro-structure prism.

17. The display device according to claim 12, wherein the display panel further comprises: a first substrate and a second substrate arranged facing each other, wherein
a side of the first substrate facing away from the second substrate is the light exit side of the display panel, and
the first micro-structure, the second micro-structure and the third micro-structure are located on a side of the second substrate facing the first substrate.

18. The display device according to claim 17, wherein
each of the first micro-structure, the second micro-structure and the third micro-structure includes a plurality of micro-structure prisms located on the second substrate and protruding toward the first substrate, each micro-structure prism having an inclined surface, and the plurality of micro-structure prisms being configured to enable light incident into the second substrate to emit as light of a particular wavelength.

19. The display device according to claim 12, wherein the display panel further comprises:
a first substrate and a second substrate arranged facing each other, and
an optical film located on a side of the second substrate facing the first substrate, wherein
a side of the first substrate facing away from the second substrate is the light exit side of the display panel, and
the first micro-structure, the second micro-structure and the third micro-structure are located on a side of the optical film facing the first substrate.

20. The display device according to claim 19, wherein
each of the first micro-structure, the second micro-structure and the third micro-structure includes a plurality of micro-structure prisms located on the optical film and protruding toward the first substrate, each micro-structure prism having an inclined surface, and the plurality of micro-structure prisms being configured to enable light incident into the optical film to emit as light of a particular wavelength.
